(19) United States
(12) Patent Application Publication
(10) Pub. No.: US 2026/0045572 A1
(43) Pub. Date: Feb. 12, 2026

(54) ALKYL CARBONATES AS REDUCING AGENTS IN HYDROMETALLURGY

(71) Applicant: BASF SE, Ludwigshafen Am Rhein (DE)

(72) Inventors: Wolfgang ROHDE, Ludwigshafen (DE); Tobias ELWERT, Schwarzheide (DE); Marc DUCHARDT, Ludwigshafen (DE); Fabian SEELER, Ludwigshafen (DE)

(21) Appl. No.: 19/100,778

(22) PCT Filed: Aug. 22, 2023
(86) PCT No.: PCT/EP2023/073066

§ 371 Date: Feb. 3, 2025

(30) Foreign Application Priority Data
Aug. 23, 2022 (EP) 22191825.3

(51) Int. Cl. H01M 10/54; C22B 3/00; C22B 3/08; C22B 3/44; C22B 7/00; C22B 47/00

(52) U.S. Cl. CPC H01M 10/54; C22B 3/08; C22B 3/44; C22B 7/007; C22B 23/0461; C22B 47/00

(57) ABSTRACT

Disclosed herein are methods for extracting one or more metals from a material, wherein the method includes: contacting the material with an acidic aqueous solution having a pH less than 7, and reducing, with an alkyl carbonate, one or more metal oxides selected from nickel oxide, cobalt oxide, and manganese oxide; where the material includes the one or more metal oxides. Also disclosed are methods including extracting one or more metals from a material to obtain an aqueous solution comprising metal ions, and separating the metal ions to obtain at least one essentially pure metal ion solution and/or at least one essentially pure solid metal ion salt. Further disclosed are methods for recycling at least one battery material selected from a lithium ion battery, lithium ion battery waste, lithium ion battery production scrap, lithium ion cell production scrap, lithium ion cathode active material, and combinations thereof.

The project leading to this application has received funding from Bundesministerium für Wirtschaft und Klimaschutz (DE; FKZ:16BZF101A); the applicant bears responsibility for all disclosures herein.

### FIELD OF THE INVENTION

Disclosed herein are methods for extracting one or more metals from a material, wherein the method comprises: contacting the material with an acidic aqueous solution having a pH less than 7, and reducing, with an alkyl carbonate, one or more metal oxides chosen from nickel oxide, cobalt oxide, and manganese oxide; wherein the material comprises the one or more metal oxides.

Also disclosed are methods comprising extracting one or more metals from a material to obtain an aqueous solution comprising metal ions, and separating the metal ions to obtain at least one essentially pure metal ion solution and/or at least one essentially pure solid metal ion salt.

Further disclosed are methods for recycling at least one battery material chosen from a lithium ion battery, lithium ion battery waste, lithium ion battery production scrap, lithium ion cell production scrap, lithium ion cathode active material, and combinations thereof.

### BACKGROUND

Lithium ion battery materials and value metal ores (e.g. manganese ore) are complex mixtures of various elements and compounds. For example, many lithium ion battery materials contain valuable metals such as lithium, aluminum, nickel, cobalt, and/or manganese. It may be desirable to recover various elements and compounds from lithium ion battery materials and value metal ores. For example, it may be advantageous to recover lithium, aluminum, nickel, cobalt, and/or manganese.

High purity lithium is a valuable resource. Many sources of lithium, such as lithium ion batteries, lithium ion battery waste, lithium containing water, e.g. ground water, and raw lithium containing ores, are complex mixtures of various elements and compounds. The removal and purification of lithium from a material, such as a lithium ion battery material, are exemplary steps in the recycling of lithium ion batteries. Lithium ion battery materials are complex mixtures of various elements and compounds, and it may be desirable to remove various non-lithium impurities. Such impurities may exist in a variety of oxidation states which may impact, for example, the efficiency of a leaching process. For example, in some leaching processes high oxidation state metals may be more or less efficiently leached than low or zero oxidation state metals. Some non-lithium impurities are also valuable resources, and it may additionally be desirable to separate and purify various elements and compounds from such materials.

Accordingly, there is a need for processes for removing lithium from materials such as, for example, a battery material and processes for recycling lithium ion battery materials. There is also a need for processes for extracting and/or purifying value metals from ores. For example, there is a need for leaching methods for efficiently and effectively leaching complex mixtures of various elements and compounds such as, for example, mixed metals coexisting in a variety of oxidation states. For example, there is a need for economic processes with high lithium recovery and high lithium purity. There is also a need for economic processes with high recovery and high purity for removing value metals such as, for example, nickel and cobalt, from materials

CN 113 363 609 A discloses a method for recycling a positive electrode material of a waste lithium battery by a fluid gradual solidification method. The method comprises the following steps: S1—adding the positive electrode material to a mixture of a salting agent and a fluidizing agent, and stir it evenly; S2—heat preservation and reaction of the mixture of the positive electrode material, the salting agent, and the fluidizing agent obtained in step S1 to obtain a solid metal salt; S3—adding the obtained solid metal salt mixture to water for dissolution, and then filtering to obtain a salt solution of lithium, cobalt, nickel, and manganese. The salting agent is selected from the group consisting of perchloric acid, hydrochloric acid, sulfuric acid, nitric acid, hydrogen sulfate, mixtures of disodium, dipotassium hydrogen sulfate, sodium dihydrogen sulfate, and potassium dihydrogen sulfate, the water content in the salting agent is less than 10 wt. %, and the ratio of dosing is 0.5-2:1. The fluidizing agent is selected from the group consisting of propylene carbonate, diethyl carbonate, and methyl ethyl carbonate, dimethyl carbonate ester, ethylene carbonate, methanol, ethanol, acetic acid, formic acid, propionic acid, malonic acid, N-methylpyrrolidone, N,N-dimethylformamide, N,N-dimethylethylamide, water, Tween 20, and Tween 80, and the ratio of the added mass of the fluidizing agent to the added mass of the positive electrode material is 0.005-0.1:1.

### SUMMARY OF THE INVENTION

Disclosed are methods for extracting one or more metals from a material, wherein the method comprises: contacting the material with an acidic aqueous solution having a pH less than 7, and reducing, with an alkyl carbonate, one or more metal oxides chosen from nickel oxide, cobalt oxide, and manganese oxide; wherein the material comprises the one or more metal oxides.

### BRIEF DESCRIPTION OF THE DRAWINGS

FIG. 1 depicts an exemplary process consistent with some embodiments of the disclosure.

FIG. 2 depicts an exemplary continuous process consistent with some embodiments of the disclosure.

FIG. 3 depicts an XRD pattern of an exemplary black mass. Typically the lithium metal oxides therein are characterized by a reflection at 2theta of 18.5° the reflections attributed to lithium nickel, cobalt, manganese oxide are indicated by the letter b.

### DETAILED DESCRIPTION

Disclosed are methods for extracting one or more metals from a material, wherein the method comprises: contacting the material with an acidic aqueous solution having a pH less than 7, and reducing, with an alkyl carbonate, one or more metal oxides chosen from nickel oxide, cobalt oxide, and manganese oxide; wherein the material comprises the one or more metal oxides.

In some embodiments, the alkyl carbonate is a cyclic alkyl carbonate. In some embodiments, the cyclic alkyl carbonate is chosen from ethylene carbonate, propylene carbonate, and butylene carbonate. In some embodiments, the alkyl carbonate is chosen from diethyl carbonate, dimethyl carbonate, dipropyl carbonate, ethyl methyl carbonate, propyl methyl carbonate, ethyl propyl carbonate ethylene carbonate, propylene carbonate, butylene carbonate, and fluoroalkyl carbonates. In some embodiments, the alkyl carbonate comprises a lithium ion battery electrolyte condensate.

In some embodiments, a mass ratio of the material to the alkyl carbonate ranges from 1:1 to 1:0.001.

In some embodiments, the material comprises cathode active material of formula LiₚM_{q}M′ᵣOₛ; wherein: M comprises one or more metals chosen from nickel, manganese, and cobalt; M′ comprises one or more metals chosen from Mg, Ca, Ba, Al, Ti, Zr, Zn, Fe, V, and Mo; p ranges from 1 to 1.4; q ranges from 0.6 to 2; r ranges from 0 to 1; and s ranges from 2 to 4.

In some embodiments, the material comprises cathode active material of formula Li₍₁₊ₓ₎(NiₐCo_{b}Mn_{c}M′_{d})₍₁₋ₓ₎O₂, wherein: M′ is chosen from Mg, Ca, Ba, Al, Ti, Zr, Zn, Mo, V and Fe; zero≤x≤0.2; 0.1≤a≤0.95, zero≤b≤0.9, or 0.05<b≤0.5; zero≤c≤0.6; zero≤d≤0.1; and a+b+c+d=1.

In some embodiments, the material comprises cathode active material of formula Li[NiₕCoᵢAlⱼ]O₂₊ᵣ, wherein: h ranges from 0.8 to 0.95; i ranges from 0.1 to 0.3; j ranges from 0.01 to 0.10; and r ranges from zero to 0.4.

In some embodiments, the material comprises cathode active material of formula Li₍₁₊ₓ₎Mn_{2-x-z}M′_{Z}O₄, wherein: x ranges from zero to 0.2; z ranges from zero to 0.1; and M′ is chosen from Al, Mg, Ni, Co, Fe, Ti, V, Zr and Zn.

In some embodiments, the material comprises cathode active material of formula xLi_{(1+1/3)}M(_{2/3})O₂·yLiMO₂·zLiM′O₂, wherein M comprises at least one metal of Mn, Ni, Co of oxidation state +4, M′ is at least one transition metal, and 0<x<1, 0<y<1, 0<z<1 and x+y+z=1.

In some embodiments, the material comprises at least one lithium ion battery material chosen from a lithium ion battery, lithium ion battery waste, lithium ion battery production scrap, a black mass, lithium ion cell production scrap, lithium ion cathode active material, and combinations thereof.

In some embodiments, the material comprises: from 0.1 weight percent to 10 weight percent lithium, from 0 weight percent to 60 weight percent nickel, from 0 weight percent to 20 weight percent cobalt, from 0 weight percent to 20 weight percent copper, from 0 weight percent to 20 weight percent aluminum, from 0 weight percent to 20 weight percent iron, and from 0 weight percent to 20 weight percent manganese; wherein each weight percent is by total weight of the material and the sum of nickel, cobalt, and manganese is more than zero weight percent.

In some embodiments, the acidic aqueous solution has a concentration of acid ranging from 18 mol/L to 0.0001 mol/L.

In some embodiments, the acidic aqueous solution comprises H₂SO₄.

Also disclosed are methods comprising extracting one or more metals from a material according to a process disclosed herein to obtain an aqueous solution comprising metal ions, and separating the metal ions to obtain at least one essentially pure metal ion solution and/or at least one essentially pure solid metal ion salt.

Also disclosed are methods for recycling at least one battery material chosen from a lithium ion battery, lithium ion battery waste, lithium ion battery production scrap, lithium ion cell production scrap, lithium ion cathode active material, and combinations thereof, wherein the method comprises: optionally, heat treating the at least one battery material at a temperature ranging from 350° C. to 900° C., mechanically comminuting the at least one battery material to obtain a black mass, optionally, sorting the black mass to obtain a fine fraction and a course fraction, and subjecting the black mass, optionally the fine fraction, the course fraction, or the fine fraction and the course fraction, to a method for extracting one or more metals from a material disclosed herein.

Also disclosed are methods for leaching a material comprising one or more metals in a zero oxidation state and one or more chosen from metal oxides, metal hydroxides, and combinations thereof, wherein the method comprises: contacting the material with an oxidizing acidic aqueous solution having a pH less than 6, and subsequently reducing the one or more chosen from metal oxides, metal hydroxides, and combinations thereof with an alkyl carbonate.

In some embodiments, the material is from a manganese ore extraction.

### Definitions

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, a “reducing agent” is a compound capable of reducing a metal oxide and/or a metal hydroxide. For example, some reducing agents are capable of reducing some metal oxides and/or some metal hydroxides but not others.

As used herein, an “oxidizing acidic aqueous solution” is an aqueous solution having a pH less than 7 capable of oxidizing a metal in a zero oxidation state. For example, some oxidizing acidic aqueous solutions are capable of oxidizing some metals in a zero oxidation state but not others. An example of an oxidizing acidic aqueous solution is an aqueous solution comprising sulfuric acid. An additional example of an oxidizing acidic aqueous solution is an aqueous solution comprising sulfuric acid and O₂.

As used herein, an “oxidizing agent” is a compound capable of oxidizing a metal in a zero oxidation state. For example, some oxidizing agents are capable of oxidizing some metals in a zero oxidation state but not others. An example of an oxidizing agent is O₂ such as in air.

As used herein, a “solution” is a combination of a fluid and one or more compounds. For example, each of the one or more compounds in the solution may or may not be dissolved in the fluid.

As used herein, an “essentially pure metal ion solution” is a solution comprising a metal ion, a counter ion, a solvent; wherein the total weight of the metal ion and counter ion is at least 50% by weight excluding the weight of solvent.

As used herein, an “essentially pure solid metal ion salt” is a solid comprising a metal ion and a counter ion; wherein the total weight of the metal ion and counter ion is at least 50% by weight of the solid excluding the weight of solvent.

As used herein, the term “sparging” refers to dispersing a gas through a liquid.

As used herein, the term “base” refers to a material capable of reacting with a hydronium ion and to increase the pH-value of an acidic solution.

As used herein, the term “standard electrode potential” has its common usage in the field of electro-chemistry and is the value of the electromotive force of an electrochemical cell in which molecular hydrogen under at 1 bar and 298.15 K is oxidized to solvated protons at the standard hydrogen electrode. The potential of the standard hydrogen electrode is zero Volts by definition. An exemplary reference is: Johnstone, A. H. “CRC Handbook of Chemistry and Physics” 69th Edition, Editor in Chief: R C Weast, CRC Press Inc., Boca Raton, Florida, 1988.

As used here, the term “alkyl carbonate” are compounds and/or mixtures of compounds of the form

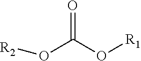

wherein R₁ and R₂ may be the same, different, or connected to form a cyclic ring; and wherein R₁ and R₂ each independently represent an alkyl group or R₁ and R₂ together represent a cyclic alkyl ring. In some embodiments, R₁ and R₂ are each independently chosen from C₁ to C₅ alkyls. In some embodiments, R₁ and R₂ are the same and chosen from C₁ to C₅ alkyls. In some embodiments, R₁ and R₂ together represent a cyclic alkyl ring; wherein R₁ and R₂ comprise from 2 to 5 ring carbon atoms.

As used herein, “alkyl” or “alkyl group,” includes straight-chain, branched, and cyclic hydrocarbons.

As used herein, the term “lithium ion battery electrolyte solvent” refers to a composition obtained from a lithium ion battery wherein the composition comprises one or more alkyl carbonates.

As used herein, the term “cathode active material” refers to a material capable of storing and releasing charge in the form of lithium ions.

As used herein, the term “ore” refers to a naturally occurring solid material from which a metal can be extracted as well as concentrates derived therefrom, e.g., by floatation.

Disclosed herein are methods for extracting one or more metals from a material, wherein the method comprises: contacting the material with an acidic aqueous solution having a pH less than 7, and reducing, with an alkyl carbonate, from the material one or more metal oxides chosen from nickel oxide, cobalt oxide, and manganese oxide. Also disclosed are methods comprising extracting one or more metals from a material to obtain an aqueous solution comprising metal ions, and separating the metal ions to obtain at least one essentially pure metal ion solution and/or at least one essentially pure solid metal ion salt. Further disclosed methods are for recycling at least one battery material chosen from a lithium ion battery, lithium ion battery waste, lithium ion battery production scrap, lithium ion cell production scrap, lithium ion cathode active material, and combinations thereof.

### Materials:

The present disclosure provides for methods extracting one or more metals from a material and the material comprises one or more metal oxides. In some embodiments, the metal oxides comprise metal in a high valent oxidation stage that cannot be leached completely by mere acid leaching without electron transfer agents resulting in lower valent metal species. An example is manganese(IV)-oxide which is poorly soluble in sulfuric acid but dissolves as manganese(II)-sulfate in the presence of an electron transfer agent or reducing agent like hydrogen peroxide and sulfur dioxide.

In some embodiments, the material comprises cathode active material of formula LiₚM_{q}M′ᵣOₛ; wherein: M comprises one or more metals chosen from nickel, manganese, and cobalt; M′ comprises one or more metals chosen from Mg, Ca, Ba, Al, Ti, Zr, Zn, Fe, V, and Mo; p ranges from 1 to 1.4; q ranges from 0.6 to 2; r ranges from 0 to 1; and s ranges from 2 to 4.

In some embodiments, the material comprises cathode active material of formula Li₍₁₊ₓ₎(NiₐCo_{b}Mn_{c}M′_{d})₍₁₋ₓ₎O₂, wherein: M′ is chosen from Mg, Ca, Ba, Al, Ti, Zr, Zn, Mo, V and Fe; zero≤x≤0.2; 0.1≤a≤0.95, zero≤b≤0.9, or 0.05<b≤0.5; zero≤c≤0.6; zero≤d≤0.1; and a+b+c+d=1.

In some embodiments, the material comprises cathode active material of formula Li[NiₕCoᵢAlⱼ]O₂₊ᵣ, wherein: h ranges from 0.8 to 0.95; i ranges from 0.1 to 0.3; j ranges from 0.01 to 0.10; and r ranges from zero to 0.4.

In some embodiments, the material comprises cathode active material of formula Li₍₁₊ₓ₎Mn_{2-x-z}M′_{z}O₄, wherein: x ranges from zero to 0.2; z ranges from zero to 0.1; and M′ is chosen from Al, Mg, Ni, Co, Fe, Ti, V, Zr and Zn.

In some embodiments, the material comprises cathode active material of formula xLi_{(1+1/3)}M(_{2/3})O₂·yLiMO₂·zLiM′O₂, wherein M′ comprises at least one metal of oxidation state +4. In some embodiments, the material comprises cathode active material of formula xLi_{(1+1/3)}M_{(2/3)}O₂·yLiMO₂·zLiM′O₂, wherein M comprises at least one metal of Mn, Ni, Co of oxidation state +4, M′ is at least one transition metal, and 0<x<1, 0<y<1, 0<z<1 and x+y+z=1.

In some embodiments, the material comprises at least one lithium ion battery material chosen from a lithium ion battery, lithium ion battery waste, lithium ion battery production scrap, a black mass, lithium ion cell production scrap, lithium ion cathode active material, and combinations thereof.

In some embodiments, the material comprises: from 0.1 weight percent to 10 weight percent lithium, from 0 weight percent to 60 weight percent nickel, from 0 weight percent to 20 weight percent cobalt, from 0 weight percent to 20 weight percent copper, from 0 weight percent to 20 weight percent aluminum, from 0 weight percent to 20 weight percent iron, and from 0 weight percent to 20 weight percent manganese; wherein each weight percent is by total weight of the material and the sum of nickel, cobalt, and manganese is more than zero weight percent.

In some embodiments, a material comprises one or more metals in a zero oxidation state and one or more chosen from metal oxides, metal hydroxides, and combinations thereof.

In some embodiments, the material is a lithium ion battery material comprising one or more chosen from black mass, cathode active material, cathodes, cathode active material precursors, and combinations thereof.

In some embodiments, the material comprises one or more chosen from nickel, cobalt, manganese, and combinations thereof.

In some embodiments, the one or more metals in a zero oxidation state is chosen from nickel, cobalt, copper, aluminum, iron, manganese, rare earth metals, and combinations thereof.

In some embodiments, the metal oxides are chosen from nickel oxides, cobalt oxides, copper oxides, aluminum oxide, iron oxides, manganese oxides, rare earth oxides, and combinations thereof.

In some embodiments, the metal hydroxides are chosen from nickel hydroxides, cobalt hydroxides, copper hydroxides, aluminum hydroxide, iron hydroxides, manganese hydroxides, rare earth hydroxides, and combinations thereof.

In some embodiments, the material comprises: from 0.1 weight percent to 10 weight percent lithium, from 0 weight percent to 60 weight percent nickel, from 0 weight percent to 20 weight percent cobalt, from 0 weight percent to 20 weight percent copper, from 0 weight percent to 20 weight percent aluminum, from 0 weight percent to 20 weight percent iron, and from 0 weight percent to 20 weight percent manganese; wherein each weight percent is by total weight of the material.

In some embodiments, the material, or a precursor thereof, is pyrolyzed prior to leaching. In some embodiments, the pyrolysis is performed under an inert atmosphere, an oxidizing atmosphere, a reducing atmosphere, or a combination thereof.

In some embodiments, the material is a lithium ion battery material comprising one or more chosen from black mass, cathode active material, cathodes, cathode active material precursors, and combinations thereof.

“Black mass” refers to materials comprising lithium derived from, for example, a lithium ion battery, lithium ion battery waste, lithium ion battery production scrap, lithium ion cell production scrap, lithium ion cathode active material, and/or combinations thereof by mechanical processes such as mechanical comminution. For example, black mass may be derived from battery scrap by mechanically treating the battery scrap to obtain the active components of the electrodes such as graphite and cathode active material and may include impurities from the casing, electrode foils, cables, separator, and electrolyte. In some examples, the battery scrap may be subjected to a heat treatment to pyrolyze organic (e.g. electrolyte) and polymeric (e.g. separator and binder) materials. Such a heat treatment may be performed before or after mechanical comminution of the battery material. In some embodiments, the black mass is subjected to a heat treatment.

Lithium ion batteries may be disassembled, punched, milled, for example in a hammer mill, rotor mill, and/or shredded, for example in an industrial shredder. From this kind of mechanical processing the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., used batteries or from production waste such as off-spec material. In some embodiments a material is obtained from mechanically treated battery scraps, for example from battery scraps treated in a hammer mill a rotor mill or in an industrial shredder. Such material may have an average particle diameter (D50) ranging from 1 μm to 1 cm, such as from 1 μm to 500 μm, and further for example, from 3 μm to 250 μm.

Larger parts of the battery scrap like the housings, the wiring and the electrode carrier films may be separated mechanically such that the corresponding materials may be excluded from the battery material that is employed in the process.

Mechanically treated battery scrap may be subjected to a solvent treatment in order to dissolve and separate polymeric binders used to bind the transition metal oxides to current collector films, or, e.g., to bind graphite to current collector films. Suitable solvents are N-methylpyrrolidone, N,N-dimethyl-formamide, N,N-dimethylacetamide, N-ethylpyrrolidone, and dimethylsulfoxide, in pure form, as mixtures of at least two of the foregoing, or as a mixture with 1% to 99% by weight of water.

In some embodiments, mechanically treated battery scrap may be subjected to a heat treatment in a wide range of temperatures under different atmospheres. In some embodiments, the temperature ranges from 100° C. to 900° C. In some embodiments, lower temperatures below 300° C. may serve to evaporate residual solvents from the battery electrolyte, at higher temperatures the binder polymers may decompose while at temperatures above 400° C. the composition of the inorganic materials may change as some transition metal oxides may become reduced either by the carbon contained in the scarp material or by introducing reductive gases. In some embodiments, a reduction of lithium metal oxides may be avoided by keeping the temperature below 400° C. and/or by removing carbonaceous materials before the heat treatment.

In some embodiments, the heat treatment is performed at a temperatures ranging from 350° C. and 900° C. In some embodiments, the heat treatment is performed at a temperatures ranging from 450° C. to 800° C. In some embodiments, the heat treatment is performed under an inert, oxidizing, or reducing atmosphere. In some embodiments, the heat treatment is performed under an inert or reducing atmosphere. In some embodiments, reducing agents are formed under the conditions of the heat treatment from pyrolyzed organic (polymeric) components. In some embodiments, a reducing gas such as H₂ and/or CO is added.

In some embodiments, the material comprises at least one chosen from lithiated nickel cobalt manganese oxide, lithiated nickel cobalt aluminum oxide, lithium metal phosphate, lithium ion battery scrap, a black mass, and combinations thereof.

In some embodiments, the material comprises lithium metal phosphate of formula LiₓMPO₄, wherein x is an integer greater than or equal to one, and M is chosen from metals, transition metals, rare earth metals, and combinations thereof.

In some embodiments, the material comprises lithiated nickel cobalt manganese oxide of formula Li₁₊ₓ(NiₐCo_{b}Mn_{c}M1_{d})₁₋ₓO₂, wherein M1 is chosen from Mg, Ca, Ba, Al, Ti, Zr, Zn, Mo, V and Fe, zero≤x≤0.2, 0.1≤a≤0.95, zero≤b≤0.9 (such as 0.05<b≤0.5), zero≤c≤0.6, zero≤d≤0.1, and a+b+c+d=1. Exemplary lithiated nickel cobalt manganese oxides include Li₍₁₊ₓ₎[Ni_{0.33}CO_{0.33}Mn_{0.33}]₍₁₋ₓ₎O₂, Li₍₁₊ₓ₎[Ni_{0.5}Co_{0.2}Mn_{0.3}]₍₁₋ₓ₎O₂, Li₍₁₊ₓ₎[Ni_{0.6}CO_{0.2}Mn_{0.2}]₍₁₋ₓ₎O₂, Li₍₁₊ₓ₎[Ni_{0.7}CO_{0.2}Mn_{0.3}]₍₁₋ₓ₎O₂, Li₍₁₊ₓ₎[Ni_{0.8}Co0.1Mn_{0.1}]₍₁₋ₓ₎O₂ each with x as defined above, and Li[Ni_{0.85}Co_{0.13}Al_{0.02}]O₂.

In some embodiments, the material comprises lithiated nickel-cobalt aluminum oxides of formula Li[NiₕCoᵢAlⱼ]O₂₊ᵣ, wherein h ranges from 0.8 to 0.95, i ranges from 0.1 to 0.3, j ranges from 0.01 to 0.10, and r ranges from zero to 0.4.

In some embodiments, the material comprises nickel, cobalt, manganese, copper, aluminum, iron, phosphorus, or combinations thereof.

In some embodiments, wherein the material has a weight ratio ranging from 0.01 to 10 of lithium to a total weight of nickel, cobalt, manganese, copper, aluminum, iron, and phosphorus. In some embodiments, wherein the material has a weight ratio ranging from 0.01 to 5 of lithium to a total weight of nickel, cobalt, manganese, copper, aluminum, iron, and phosphorus. In some embodiments, wherein the material has a weight ratio ranging from 0.01 to 2 of lithium to a total weight of nickel, cobalt, manganese, copper, aluminum, iron, and phosphorus. In some embodiments, wherein the material has a weight ratio ranging from 0.01 to 1 of lithium to a total weight of nickel, cobalt, manganese, copper, aluminum, iron, and phosphorus.

In some embodiments, the material comprises LiₓMO₂ wherein x is an integer greater than or equal to one, and M is chosen from metals, transition metals, rare earth metals, and combinations thereof.

In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof to obtain a black mass.

In some embodiments, the material has a standard electrode potential ranging from +1.1 V to −1.7 V. In some embodiments, from 0.1 weight % to 10 weight % of the material has a standard electrode potential ranging from +0.1 V to +0.8 V and from 0.1 weight % to 60 weight % of the material has a standard electrode potential ranging from −1.7 V to −0.01 V; by total weight of the material.

In some embodiments, the one or more metals in a zero oxidation state each have a standard electrode potential ranging from 1.1 V to −1.7 V. In some embodiments, the one or more metals in a zero oxidation state each have a standard electrode potential ranging from −1.7 V to +0.35 V. Standard electrode potentials for some exemplary metals in a zero oxidation state include: Al/Al³⁺ (E(0)=−1.66 V), Cu/Cu²⁺ (E(0)=+0.35 V), Co/Co²⁺ (E(0)=−0.28 V), Fe/Fe²⁺ (E(0)=−0.44 V), and Ni/Ni²⁺ (E(0)=−0.23 V).

In some embodiments, the one or more chosen from metal oxides, metal hydroxides, and combinations thereof each have a standard electrode potential ranging from +0.1 V to +1.9 V. In some embodiments, the one or more chosen from metal oxides, metal hydroxides, and combinations thereof each have a standard electrode potential ranging from 0.15 V to 1.83 V. Standard electrode potentials for some exemplary metal ions such as, for example, metal ions that may result from the dissolution of oxides or hydroxides, and metal oxides and/or metal hydroxides include: Co³⁺/Co²⁺ (E(0)=+1.83 V), NiO₂+4H⁺/Ni²⁺+2H₂O (E(0)=+1.678 V), Mn³⁺/Mn²⁺ (E(0)=+1.5415 V), and Mn(OH)₃/Mn(OH)₂+OH⁻ (E(0)=+0.15 V).

In some embodiments, the material is an ore. In some embodiments, the material is an ore comprising at least 0.1 weight % manganese, by total weight of the material. In some embodiments, the material is an ore comprising at least 1 weight % manganese, by total weight of the material. In some embodiments, the material is an ore comprising at least 10 weight % manganese, by total weight of the material.

In some embodiments, the material is an ore comprising from 0.1 weight % manganese to 65 weight % manganese, by total weight of the material. In some embodiments, the material is an ore comprising from 0.1 weight % manganese to 50 weight % manganese, by total weight of the material. In some embodiments, the material is an ore comprising from 0.1 weight % manganese to 25 weight % manganese, by total weight of the material. In some embodiments, the material is an ore comprising from 0.1 weight % manganese to 10 weight % manganese, by total weight of the material. In some embodiments, the material is an ore comprising from 1 weight % manganese to 65 weight % manganese, by total weight of the material. In some embodiments, the material is an ore comprising from 10 weight % manganese to 65 weight % manganese, by total weight of the material. In some embodiments, the material is an ore comprising from 25 weight % manganese to 65 weight % manganese, by total weight of the material. In some embodiments, the material is an ore comprising from 50 weight % manganese to 65 weight % manganese, by total weight of the material.

In some embodiments, the material comprises MnO₂. In some embodiments, the material comprises Pyrolusite.

In some embodiments, the material is from a manganese ore extraction.

### Alkyl Carbonates:

The present disclosure comprising the step of reducing, with an alkyl carbonate, from the material one or more metal oxides chosen from nickel oxide, cobalt oxide, and manganese oxide.

In some embodiments, the alkyl carbonate is a cyclic alkyl carbonate.

In some embodiments, the cyclic alkyl carbonate is chosen from ethylene carbonate, propylene carbonate, and butylene carbonate.

In some embodiments, the alkyl carbonate is chosen from diethyl carbonate, dimethyl carbonate, dipropyl carbonate, ethyl methyl carbonate, propyl methyl carbonate, ethyl propyl carbonate ethylene carbonate, propylene carbonate, butylene carbonate, and fluoroalkyl carbonates.

In some embodiments, the alkyl carbonate comprises a lithium ion battery electrolyte condensate.

This can be obtained, for example, from comminuted battery cell materials by a drying procedure at temperatures ranging from 25° C. to 300° C. at an absolute pressure ranging from 1013 mbar and 0.1 mbar. In some embodiments, the electrolyte condensate is obtained by washing the comminuted battery cell material with a suitable solvent such as, for example, water or an organic solvent chosen from alcohols, esters, carbonates, ketones, and ethers. Examples of such solvents are methanol, ethanol, propanol, isopropanol, formic acid methyl ester, acetic acid methyl ester, alkyl carbonates like dimethyl carbonate diethyl carbonates, acetone, tetrahydrofuran, and mixtures thereof. In some embodiments, an aqueous electrolyte condensate mixture is distilled, salted out, and/or phase separated to obtain the electrolyte condensate. In some embodiments the aqueous electrolyte condensate mixture is directly added to the leaching reactor as reducing agent.

In some embodiments, the molar ratio of the nickel, cobalt and manganese oxide within the material to the alkyl carbonate ranges from 1:2 to 10:1. In some embodiments, the molar ratio of the nickel, cobalt and manganese oxide within the material to the alkyl carbonate ranges from 1:2 to 8:1. In some embodiments, the molar ratio of the nickel, cobalt and manganese oxide within the material to the alkyl carbonate ranges from 1:2 to 6:1. In some embodiments, the molar ratio of the nickel, cobalt and manganese oxide within the material to the alkyl carbonate ranges from 1:2 to 4:1. In some embodiments, the molar ratio of the nickel, cobalt and manganese oxide within the material to the alkyl carbonate ranges from 1:2 to 2:1. In some embodiments, the molar ratio of the nickel, cobalt and manganese oxide within the material to the alkyl carbonate ranges from 1:2 to 1:1.

In some embodiment, the material is a cathode active material, the alkyl carbonate is dipropyl carbonate, and the mass ratio of the material to the alkyl carbonate ranges from 1:3 to 1:0.2.

In some embodiment, the material is a cathode active material, the alkyl carbonate is dimethyl carbonate, and the mass ratio of the material to the alkyl carbonate ranges from 1:2 to 1:0.1.

In some embodiment, the material is a cathode active material, the alkyl carbonate is mixed ethyl/methyl carbonate, and the mass ratio of the material to the alkyl carbonate ranges from 1:2 to 1:0.1.

In some embodiment, the material is a 1% to 20% Mn ore, the alkyl carbonate is ethylene carbonate, and the molar ratio of the manganese within the material to the alkyl carbonate ranges from 1:2 to 10:1.

### Methods:

The present disclosure provides methods for extracting one or more metals from a material, wherein the methods comprise: contacting the material with an acidic aqueous solution having a pH less than 7, and reducing, with an alkyl carbonate, from the material one or more metal oxides chosen from nickel oxide, cobalt oxide, and manganese oxide.

In some embodiments, the acidic aqueous solution has a concentration of acid ranging from 18 mol/L to 0.0001 mol/L. In some embodiments, the acidic aqueous solution has a concentration of acid ranging from 18 mol/L to 0.001 mol/L. In some embodiments, the acidic aqueous solution has a concentration of acid ranging from 18 mol/L to 0.01 mol/L. In some embodiments, the acidic aqueous solution has a concentration of acid ranging from 18 mol/L to 0.1 mol/L. In some embodiments, the acidic aqueous solution has a concentration of acid ranging from 18 mol/L to 1 mol/L. In some embodiments, the acidic aqueous solution has a concentration of acid ranging from 18 mol/L to 10 mol/L. In some embodiments, the acidic aqueous solution has a concentration of acid ranging from 17 mol/L to 1 mol/L. In some embodiments, the acidic aqueous solution has a concentration of acid ranging from 16 mol/L to 1 mol/L.

In some embodiments, the acidic aqueous solution comprises H₂SO₄.

In some embodiments, a method comprising: extracting one or more metals from a material according to a process disclosed herein to obtain an aqueous solution comprising metal ions, and separating the metal ions to obtain at least one essentially pure metal ion solution and/or at least one essentially pure solid metal ion salt.

In some embodiments, the material, or a precursor thereof, is pyrolyzed prior to leaching.

Some embodiments are methods for recycling at least one battery material chosen from a lithium ion battery, lithium ion battery waste, lithium ion battery production scrap, lithium ion cell production scrap, lithium ion cathode active material, and combinations thereof, wherein the method comprises: optionally, heat treating the at least one battery material at a temperature ranging from 350° C. to 900° C., mechanically comminuting the at least one battery material to obtain a black mass, optionally, sorting the black mass to obtain a fine fraction and a course fraction, and subjecting the black mass, optionally the fine fraction, the course fraction, or the fine fraction and the course fraction, to a method for extracting one or more metals from a material disclosed herein.

In some embodiments are methods for leaching a material comprising one or more metals in a zero oxidation state and one or more chosen from metal oxides, metal hydroxides, and combinations thereof, wherein the method comprises: contacting the material with an oxidizing acidic aqueous solution having a pH less than 6, and subsequently reducing the one or more chosen from metal oxides, metal hydroxides, and combinations thereof with an alkyl carbonate.

In some embodiments, a method for leaching comprises: contacting the material with an oxidizing acidic aqueous solution having a pH less than 6, and, subsequently, reducing one or more chosen from metal oxides, metal hydroxides, and combinations thereof with a reducing agent. In some embodiments, the material comprises one or more metals in a zero oxidation state and one or more chosen from metal oxides, metal hydroxides, and combinations thereof.

In some embodiments, the oxidizing acidic aqueous solution comprises at least one chosen from H₂SO₄, O₂, N₂O, and combinations thereof. In some embodiments, the oxidizing acidic aqueous solution comprises H₂SO₄. In some embodiments, the oxidizing acidic aqueous solution comprises one or more acids chosen from H₂SO₄, CH₃SO₃H, HNO₃, and combinations thereof. In some embodiments, the oxidizing acidic aqueous solution further comprises one or more chosen from O₂, N₂O, and combinations thereof. In some embodiments, the oxidizing acidic aqueous solution comprises an acid that is also an oxidizing agent such as, for example, H₂SO₄. In some embodiments, the oxidizing acidic aqueous solution comprises an oxidizing agent that is not an acid such as, for example, O₂, N₂O, or combinations thereof. In some embodiments, the oxidizing acidic aqueous solution comprises an acid and an oxidizing agent. In some embodiments, the oxidizing acidic aqueous solution comprises an acid that is also an oxidizing agent and further comprises an oxidizing agent that is not an acid. In some embodiments, the oxidizing agent is a high valent metal oxide compound chosen from potassium permanganate, potassium chromate, potassium dichromate, and lithium metal oxides (e.g., lithium cobalt dioxide, lithium manganese oxides, and mixed lithium nickel cobalt manganese oxides),

In some embodiments, the oxidizing acidic aqueous solution comprises H₂SO₄ and O₂. In some embodiments, the oxidizing acidic aqueous solution comprises O₂ and the O₂ is provided as air.

In some embodiments, an additional metal oxide and/or metal hydroxide is added after the contacting step and before the reducing step.

In some embodiments, the reducing agent further comprises one or more chosen from SO₂, metabisulfite salts, bisulfite salts, thiosulfate salts, dithionate salts, H₂O₂, H₂, and combinations thereof in addition to the alkyl carbonates

In some embodiments, a black mass is slurred in water at a weight percentage of black mass by total weight of the slurry ranging from 5% to 30%. In some embodiments, the slurred black mass is contacted with the oxidizing acidic aqueous solution having a pH less than 6. In some embodiments, the oxidizing acidic aqueous solution having a pH less than 6 is formed from the slurred black mass by addition of acid and/or an oxidizing agent. In some embodiments, the weight ratio of H₂SO₄ in the oxidizing acidic aqueous to black mass ranges from 1:1 to 2:1. In some embodiments, H₂SO₄ is added to adjust the pH during the contacting step.

In some embodiments, the black mass is provided as a slurry. In some embodiments, the black mass is provided as a slurry in water. In some embodiments, the black mass is provided as a slurry in aqueous side streams from subsequent treatment steps such as, for example, washing liquids from filters. In some embodiments, the black mass is provided as a solid. In some embodiments, the cathode active material is provided as a slurry. In some embodiments, the cathode active material is provided as a slurry in water. In some embodiments, the cathode active material is provided as a slurry in aqueous side streams from subsequent treatment steps such as, for example, washing liquids from filters. In some embodiments, the cathode active material is provided as a solid. In some embodiments, the mixed hydroxide precipitate is provided as a slurry. In some embodiments, the mixed hydroxide precipitate is provided as a slurry in water. In some embodiments, the mixed hydroxide precipitate is provided as a slurry in aqueous side streams from subsequent treatment steps such as, for example, washing liquids from filters. In some embodiments, the mixed hydroxide precipitate is provided as a solid.

In some embodiments, contacting the material with an oxidizing acidic aqueous solution is performed at a temperature ranging from 50° C. to 110° C. In some embodiments, contacting the material with an oxidizing acidic aqueous solution is performed for a duration ranging from 2 hours to 4 hours. In some embodiments, contacting the material with an oxidizing acidic aqueous solution is performed at a first temperature and the reducing step is performed at a second temperature, and the second temperature ranges from 70% to 20% of the first temperature.

In some embodiments, the oxidizing acidic aqueous solution comprises air. In some embodiments, the air comprises less than or equal to 3 volume % sulfur dioxide. In some embodiments, contacting the material with an oxidizing acidic aqueous solution having a pH less than 6 comprises sparging air through the oxidizing acidic aqueous solution. In some embodiments, the air is sparged through the oxidizing acidic aqueous solution at a rate of up to 20% solution volume/min.

In some embodiments, the oxidizing acidic aqueous solution has a pH ranging from −1.0 to 3.

In some embodiments, contacting the material with an oxidizing acidic aqueous solution having a pH less than 6 comprises first contacting the material with an acid and, subsequently, adding an oxidizing agent chosen from O₂, N₂O, and combinations. In some embodiments, contacting the material with an oxidizing acidic aqueous solution having a pH less than 6 comprises first contacting the material with an acid causing a formation of hydrogen gas and, subsequent to the formation of hydrogen gas, adding an oxidizing agent chosen from O₂, N₂O, a metal oxide having an oxidation state greater than or equal to +3, nickel manganese cobalt oxide, a cathode active material, and combinations. In some embodiments, contacting the material with an oxidizing acidic aqueous solution having a pH less than 6 comprises first contacting the material with an acid causing a formation of hydrogen gas, monitoring the formation of hydrogen gas by gas chromatography and/or hydrogen sensors, and, subsequent to the formation of hydrogen gas, adding an oxidizing agent chosen from O₂, N₂O, and combinations. In some embodiments, contacting the material with an oxidizing acidic aqueous solution having a pH less than 6 comprises first contacting the material with an acid causing a formation of hydrogen gas, monitoring the formation of hydrogen gas by gas chromatography and/or hydrogen sensors, and, when the concentration of hydrogen gas is less than 5 volume %, for example less than 1 volume % for example less than 0.1 volume %, adding an oxidizing agent chosen from O₂, N₂O, and combinations.

In some embodiments, the subsequent reducing step begins immediately after the contacting step begins. In some embodiments, the subsequent reducing step begins at least 1 minute after the contacting step begins. In some embodiments, the subsequent reducing step begins at least 10 minutes after the contacting step begins. In some embodiments, the subsequent reducing step begins at least 30 minutes after the contacting step begins. In some embodiments, the subsequent reducing step begins at least 1 hour after the contacting step begins. In some embodiments, the subsequent reducing step begins from 0 minutes to 2 hours after the contacting step begins.

In some embodiments, excess oxidizing gas O₂, such as in air, and/or N₂O is recycled from the off-gas back into the leaching reactor.

In some embodiments, the reducing agent further comprises SO₂ in addition to the alky carbonate and the SO₂ is purged through the solution at a rate of up to 20% solution volume/min for 1 hour to 3 hours. In some embodiments, the reducing agent further comprises SO₂ in addition to the alky carbonate and the SO₂ is provided as a mixture with O₂ or air containing 10% SO₂ or more. In some embodiments, the reducing agent further comprises SO₂ in addition to the alky carbonate and the SO₂ is not provided as a mixture with O₂ or air. In some embodiments, the reducing agent further comprises SO₂ in addition to the alky carbonate and the SO₂ is provided as pure gas having a purity of at least 90%, for example 99%, or as mixture with an inert gas such as, for example, nitrogen and/or argon.

In some embodiments, the reducing step is performed at ambient temperature.

In some embodiments, subsequent to the contacting step, the method further comprises adding a base. In some embodiments, the base is chosen from CaO, a hydroxide salt, a carbonate salt, and combinations thereof. In some embodiments, the hydroxide salt is chosen from LiOH, NaOH, KOH, NH₄OH, Ca(OH)₂, CaCO₃, Ni(OH)₂, Co(OH)₂, Mn(OH)₂, and combinations thereof.

In some embodiments, the method is performed batchwise.

In some embodiments, the method is performed continuously in at least two reaction vessels. In some embodiments, the method is performed continuously in, e.g., three, four, five, six, seven, or more reaction vessels. In some embodiments, the black mass is added to a first reaction vessel, the oxidizing agent is added to a second and/or a third reaction vessel, the cathode active material and/or mixed hydroxide precipitate is added to a fourth reaction vessel, and the reducing agent is added to a fourth, a fifth, and/or a sixth reaction vessel.

In some embodiments, excess sulfur dioxide is recycled from the off-gas back into the reactor.

In some embodiments, a reflux condenser is fitted to at least one reaction vessel.

In some embodiments, contacting the material with an oxidizing acidic aqueous solution is carried out at ambient pressure. In some embodiments, the contacting the material with an oxidizing acidic aqueous solution is carried out at an elevated pressure.

In some embodiments, the contacting step is at a temperature ranging from 20° C. to 100° C. for a duration ranging from 10 minutes to 10 hours. In some embodiments, the contacting step is at 100° C. for a duration ranging from 3 hours to 5 hours. In some embodiments, the contacting step is at 60° C. for a duration ranging from 3 hours to 5 hours. In some embodiments, the contacting step is at 25° C. for a duration ranging from 3 hours to 5 hours.

In some embodiments, the reducing step is at a temperature ranging from 20° C. to 100° C. for a duration ranging from 10 minutes to 10 hours. In some embodiments, the reducing step is at 100° C. for a duration ranging from 3 hours to 5 hours. In some embodiments, the reducing step is at 60° C. for a duration ranging from 3 hours to 5 hours. In some embodiments, the reducing step is at 25° C. for a duration ranging from 3 hours to 5 hours.

In some embodiments, the method comprising leaching a material is disclosed herein to obtain an aqueous solution comprising metal ions and separating the metal ions to obtain at least one essentially pure metal ion solution and/or at least one essentially pure solid metal ion salt.

In some embodiments, an essentially pure solid metal ion salt is a solid comprising a metal ion and a counter ion; wherein the total weight of the metal ion and counter ion is at least 50% by weight of the solid excluding the weight of solvent such as all water. In some embodiments, an essentially pure solid metal ion salt is a solid comprising a metal ion and a counter ion; wherein the total weight of the metal ion and counter ion is at least 70% by weight of the solid excluding the weight of solvent. In some embodiments, an essentially pure solid metal ion salt is a solid comprising a metal ion and a counter ion; wherein the total weight of the metal ion and counter ion is at least 80% by weight of the solid excluding the weight of solvent. In some embodiments, an essentially pure solid metal ion salt is a solid comprising a metal ion and a counter ion; wherein the total weight of the metal ion and counter ion is at least 90% by weight of the solid excluding the weight of solvent. In some embodiments, an essentially pure solid metal ion salt is a solid comprising a metal ion and a counter ion; wherein the total weight of the metal ion and counter ion is at least 95% by weight of the solid excluding the weight of solvent. In some embodiments, an essentially pure solid metal ion salt is a solid comprising a metal ion and a counter ion; wherein the total weight of the metal ion and counter ion is at least 99% by weight of the solid excluding the weight of solvent.

In some embodiments, an essentially pure metal ion solution is a solution comprising a metal ion, a counter ion, and a solvent; wherein the total weight of the metal ion and counter ion is at least 50% by weight of the solution excluding the weight of solvent. In some embodiments, an essentially pure metal ion solution is a solution comprising a metal ion, a counter ion, a solvent; wherein the total weight of the metal ion and counter ion is at least 70% by weight of the solution excluding the weight of solvent. In some embodiments, an essentially pure metal ion solution is a solution comprising a metal ion, a counter ion, a solvent; wherein the total weight of the metal ion and counter ion is at least 80% by weight of the solution excluding the weight of solvent. In some embodiments, an essentially pure metal ion solution is a solution comprising a metal ion, a counter ion, a solvent; wherein the total weight of the metal ion and counter ion is at least 90% by weight of the solution excluding the weight of solvent. In some embodiments, an essentially pure metal ion solution is a solution comprising a metal ion, a counter ion, a solvent; wherein the total weight of the metal ion and counter ion is at least 95% by weight of the solution excluding the weight of solvent. In some embodiments, an essentially pure metal ion solution is a solution comprising a metal ion, a counter ion, a solvent; wherein the total weight of the metal ion and counter ion is at least 99% by weight of the solution excluding the weight of solvent.

In some embodiments, separating the metal ions to obtain at least one essentially pure metal ion solution and/or at least one essentially pure solid metal ion salt comprises one or more of a solid/liquid separation, an extraction, a precipitation, a crystallization, and combinations thereof.

In some embodiments, the method can be performed in part or in whole as a continuous process controlled by sensors and actuators as part of a computer based process control system.

### Oxidizing Agents:

In some embodiments, the oxidizing acidic aqueous solution comprises an oxidizing agent. In some embodiments, an oxidizing agent is an acid such as, for example, H₂SO₄, HNO₃, and combinations thereof. In some embodiments, an oxidizing agent is not an acid such as, for example, O₂, N₂O, and combinations thereof.

In some embodiments, a metal oxide having an oxidation state greater than or equal to +3 is used as an oxidizing agent.

In some embodiments, the oxidizing acidic aqueous solution comprises an acid that is not an oxidizing agent and an oxidizing agent that is not an acid. In some embodiments, the oxidizing acidic aqueous solution comprises an acid that is an oxidizing agent and an oxidizing agent that is not an acid. In some embodiments, the oxidizing acidic aqueous solution comprises an acid that is not an oxidizing agent and an oxidizing agent that is an acid. In some embodiments, the oxidizing acidic aqueous solution comprises an acid that is an oxidizing agent and an oxidizing agent that is an acid. In some embodiments, the oxidizing acidic aqueous solution comprises an acid that is an oxidizing agent. In some embodiments, an acidic aqueous solution is an oxidizing acidic aqueous solution. In some embodiments, acidic aqueous solution is not an oxidizing acidic aqueous solution.

In some embodiments, an oxidizing agent has a standard electrode potential ranging from +0.1 V to +1.5 V. In some embodiments, an oxidizing agent has a standard electrode potential ranging from +0.4 V to +1.3 V. In some embodiments, an oxidizing agent has a standard electrode potential ranging from +1 V to +1.5 V.

### Reducing Agents:

In some embodiments, the reducing agent is an alkyl carbonate.

Without wishing to be bound by theory, it is believed that alkyl carbonates can reduce metal oxides by the following reaction 4MO₂+ethylene carbonate+4H₂SO₄↔4MSO₄+5H₂O+oxalic acid+CO₂.

In some embodiments, the reducing agent further comprises one or more chosen from SO₂, metabisulfite salts, bisulfite salts, dithionate salts, thiosulfate salts, H₂O₂, H₂, and combinations thereof.

Hydrogen peroxide can function as reductant or oxidant, depending on the reaction partner. Possible oxidation and reduction reactions are: H₂O₂↔O₂+2e⁻+2 H⁺, and H₂O₂+2e⁻+2 H₂⁺↔2 H₂O. In some embodiments, the standard electrode potential of the reaction partner impacts which reaction occurs. For example, under certain conditions permanganate (MnO₄⁻) is reduced by hydrogen peroxide while Fe²⁺ is oxidized. In some embodiments, more acidic conditions benefit the oxidation reaction as H⁺ is needed to form water and less acidic conditions benefit the reduction reaction as H⁺ is produced during that reaction. In some embodiments, the following reactions may or may not occur depending on the one or more metals M and the conditions used:

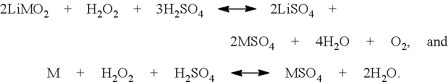

### Exemplary Batch Process:

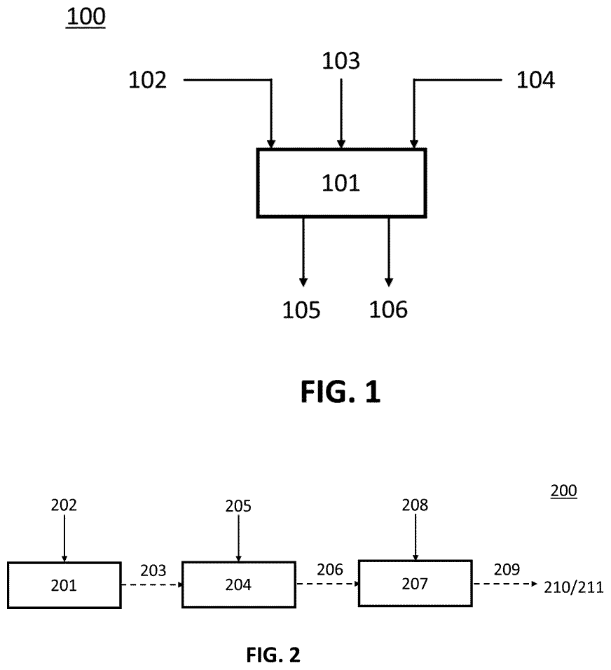

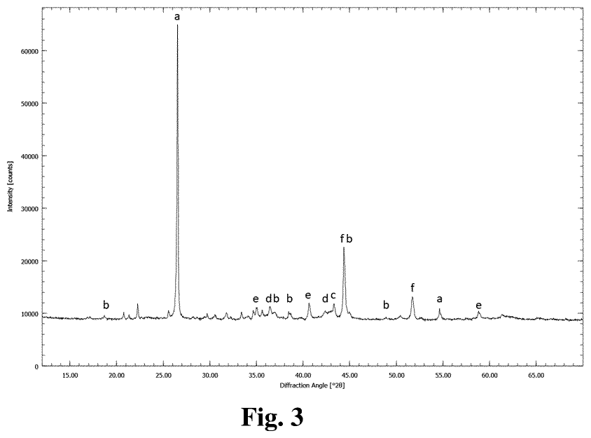

FIG. 1 depicts and exemplary batch process (100) consistent with some embodiments of the disclosure. In some embodiments, a material (102) such as a black mass comprising nickel, cobalt, and manganese species is acid leached in a continuously stirred reaction vessel (101) comprising an acidic aqueous solution at a pH less than 1. In some embodiments, hydrogen gas is evolved. In some embodiments, an oxidizing agent such as, for example, O₂ and/or N₂O is added (103). In some embodiments, the pH is adjusted up to a pH ranging from 1 to 2 with, for example, cathode active material and/or mixed hydroxide precipitate and a reducing agent such as an alkyl carbonate is introduced (104). In some embodiments, the obtained liquid phase (106) and a solid phase (105) are separated by a solid/liquid separation e.g. filtration, centrifugation, and/or sedimentation.

### Exemplary Continuous Process:

FIG. 2 depicts and exemplary continuous process (200) consistent with some embodiments of the disclosure. In some embodiments, a material (202) such as a black mass comprising nickel, cobalt, and manganese species is acid leached in continuously stirred reaction vessel (201) comprising an acidic aqueous solution at a pH less than 1. In some embodiments, the acid leaching is further carried out in one or more additional continuously stirred reaction vessels (203). In some embodiments, an oxidizing agent such as, for example, O₂ and/or N₂O is added (205) to a continuously stirred reaction vessel (204). In some embodiments, the acid leaching in the presence of an added oxidizing agent is further carried out in one or more additional continuously stirred reaction vessels (206). In some embodiments, the pH is adjusted up to a pH ranging from 1 to 2 with, for example, cathode active material and/or mixed hydroxide precipitate and a reducing agent such as an alkyl carbonate is introduced (208) to a continuously stirred reaction vessel (207). In some embodiments, the leaching in the presence of an added reducing agent is further carried out in one or more additional continuously stirred reaction vessels (209). In some embodiments, the obtained liquid phase (211) and a solid phase (210) are separated by a solid/liquid separation e.g. filtration, centrifugation, and/or sedimentation.

Claims or descriptions that include “or” or “and/or” between at least one members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or all the group members are present in, employed in, or otherwise relevant to a given product or process.

Furthermore, the disclosure encompasses all variations, combinations, and permutations in which at least one limitation, element, clause, and descriptive term from at least one of the listed claims is introduced into another claim. For example, any claim that is dependent on another claim can be modified to include at least one limitation found in any other claim that is dependent on the same base claim. Where elements are presented as lists, such as, e.g., in Markush group format, each subgroup of the elements is also disclosed, and any element(s) can be removed from the group. It should be understood that, in general, where the disclosure, or aspects of the disclosure, is/are referred to as comprising particular elements and/or features, embodiments of the disclosure or aspects of the disclosure consist, or consist essentially of, such elements and/or features. For purposes of simplicity, those embodiments have not been specifically set forth in haec verba herein. Where ranges are given, endpoints are included. Furthermore, unless otherwise indicated or otherwise evident from the context and understanding of one of ordinary skill in the art, values that are expressed as ranges can assume any specific value or sub range within the stated ranges in different embodiments of the disclosure, unless the context clearly dictates otherwise.

Those of ordinary skill in the art will recognize or be able to ascertain using no more than routine experimentation, many equivalents to the specific embodiments of the disclosure described herein. Such equivalents are intended to be encompassed by the following claims.

### EXAMPLES

The following examples are intended to be illustrative and are not meant in any way to limit the scope of the disclosure.

### Abbreviations

% percent
K₂CO₃ potassium carbonate
Na₂CO₃ sodium carbonate
Na₂B₄O₇ sodium tetraborate
p.a. grade pro analysis grade
n.d. not determined
wt % weight percent
NaOH sodium hydroxide
Li lithium
Ni nickel
Co cobalt
Mn manganese
Cu copper
Al aluminum
Fe iron
P phosphorus
F fluorine
Ca calcium

### Exemplary Elemental Analysis

Elemental analysis of solid samples was done by digestion in nitric acid and hydrochloric acid (feed samples and Examples 1 and 2) or digestion by K₂CO₃—Na₂CO₃/Na₂B₄O₇ fusion and dissolution of the fusion residue in hydrochloric acid (Examples 3 and 4).

The metals within the obtained sample solutions were determined by optical emission spectroscopy using an inductively coupled plasma (ICP-OES).

Some elemental concentrations were also measured by X-ray fluorescence employing an Epsilon 4 DY-6024 from Malvern Panalytical which had been calibrated with data from ICP-OES measurements.

Elemental analysis of fluorine and fluoride was performed in accordance with DIN EN 14582:2016-12 with regard to the sample preparation for the overall fluorine content determination (solid samples); the detection method was an ion selective electrode measurement. DIN 38405-D4-2:1985-07 (water samples; digestion of inorganic solids with subsequent acid-supported distillation and fluoride determination using ion selective electrode).

Total carbon was determined by gas chromatography with a thermal conductivity detector of the gases obtained after combustion of the samples.

Sulfur was determined by catalytical combustion of the sample in an inert gas/oxygen atmosphere the sulfur is hereby converted to a mixture of SO₂ and SO₃. The formed SO₃ was subsequently reduced to SO₂ with copper granules. After drying and separation of the combustion gases, sulfur was detected and quantified as SO₂ via thermal conductivity or IR spectrometry.

### Condensate of Electrolyte Solvents

The condensate of electrolyte solvents used in Example 4 was obtained by drying shredded lithium ion batteries at an average temperature of 87° C. at an average pressure of 222 mbar containing about 53.8% ethyl methyl carbonate, 37.9% diethyl carbonate, 4.1% ethylene carbonate and 2.8% biphenyl measured by gas chromatography coupled with mass spectrometry.

### Cathode Active Material

The cathode active material (CAM) used in Examples 1 and 2 was a commercially available CAM from BASF Corp called HED™ NCM the composition of which was: 49.8 weight % Ni, 5.9 weight % Co, 2.6 weight % Mn, and 7.3 weight % Li.

### Example 1

In this example, a cathode active material is leached and an alkyl carbonate is not used. 25.06 g of an NCM111 material was suspended in 145.5 g de-ionized water with stirring. To this suspension, 60 g of sulfuric acid (96 wt. %) was slowly added during 70 min under stirring. The temperature was observed to rise from room temperature to 50° C. Subsequently, the reaction mixture was heated to 80° C. The mixture was kept at this temperature for 30 min and then further heated to 100° C. The mixture was kept at 100° C. for another 80 min. Afterwards, the mixture was cooled down to room temperature and filtered from the remaining residue. The residue was dried to afford 14.75 g of dry solid residue. The solid residue was analyzed by ICP-OES and the results are provided in Table 1.

### Example 2

In this example, a cathode active material is leached and an alkyl carbonate is used.

Example 2 was conducted according to the procedure described in Example 1 except 7.5 g diethyl carbonate was added during the 30 min period at 80° C., and the resulting mixture was kept at 100° C. for 60 min. Example 2 afforded 10.64 g of dry solid residue.

The solid residue was analyzed by ICP-OES and the results are provided in Table 1.

### Example 3

In this example, a cathode active material is leached and an alkyl carbonate is used.

Example 3 was conducted according to the procedure described in Example 1 except 6.6 g ethylene carbonate was added as a melt during the 30 min period at 80° C., and the resulting mixture was kept at 1 00° C. for 60 min. At the end of the procedure, there was no solid residue present. The solid residue was analyzed by ICP-OES and the results are provided in Table 1.

### Example 4

In this example, a cathode active material is leached and a condensate of electrolyte solvents comprising alkyl carbonates is used.

Example 4 was conducted according to the procedure described in Example 1 except 7.3 g of the condensate of electrolyte solvents was added during the 30 min period at 80° C., and the resulting mixture was kept at 92° C. for 60 min. Example 4 afforded 4.51 g of dry solid residue. The solid residue was analyzed by ICP-OES and the results are provided in Table 1.

TABLE 1

| | | wt % of | | wt % of | | wt % of | | wt % of | |
|---|---|---|---|---|---|---|---|---|---|
| | Alkyl | Ni in | Yield | Co in | Yield | Mn in | Yield | Li in | Yield |
| Example | carbonate | residue | (%) | residue | (%) | residue | (%) | residue | (%) |
| 1 | None | 15.3 | 54.5 | 16.2 | 49.6 | 29.3 | 5.8 | 0.31 | 97.7 |
| 2 | Diethyl | 7.7 | 83.5 | 8.9 | 80.0 | 42 | 2.52 | 0.25 | 98.6 |
| | carbonate | | | | | | | | |
| 3 | Ethylene | 0 | 100 | 0 | 100 | 0 | 100 | 0 | 100 |
| | carbonate | | | | | | | | |
| 4 | mixture | 0.13 | 99.9 | 0.65 | 99.4 | 56.0 | 45.0 | 0.07 | 99.8 |

Comparing Example 1 with Examples 2 through 4, one observes that addition of one or more alkyl carbonates increases the leaching efficiency. Without wishing to be bound by theory, it is believed that the alkyl carbonates act as a reducing agent to improve the leaching efficiency.

1. A method for extracting one or more metals from a material, wherein the method comprises:
contacting the material with an acidic aqueous solution having a pH less than 7 at a temperature in the range of from 20° C. to 100° C. for a duration ranging from 10 minutes to 10 hours, and
reducing, with an alkyl carbonate, one or more metal oxides selected from the group consisting of nickel oxide, cobalt oxide, and manganese oxide from the material, at a temperature in the range of from 20° C. to 100° C. for a duration ranging from 10 minutes to 10 hours.

2. The method according to claim 1, wherein the alkyl carbonate is a cyclic alkyl carbonate.

3. The method according to claim 2, wherein the cyclic alkyl carbonate is selected from the group consisting of ethylene carbonate, propylene carbonate, and butylene carbonate.

4. The method according to claim 1, wherein the alkyl carbonate is selected from the group consisting of diethyl carbonate, dimethyl carbonate, dipropyl carbonate, ethyl methyl carbonate, propyl methyl carbonate, ethyl propyl carbonate ethylene carbonate, propylene carbonate, butylene carbonate, and fluoroalkyl carbonates.

5. The method according to claim 1, wherein the alkyl carbonate comprises a lithium ion battery electrolyte solvent.

6. The method according to claim 1, wherein the molar ratio of the one or more metal oxides selected from the group consisting of nickel oxide, cobalt oxide, and manganese oxide in the material to the alkyl carbonate ranges from 1:2 to 10:1.

7. The method according to claim 1, wherein the material comprises cathode active material of formula LiₚM_{q}M′ᵣOₛ; wherein:
M comprises one or more metals selected from the group consisting of nickel, manganese, and cobalt;
M′ comprises one or more metals selected from the group consisting of Mg, Ca, Ba, Al, Ti, Zr, Zn, Fe, V, and Mo;
p ranges from 1 to 1.4;
q ranges from 0.6 to 2;
r ranges from 0 to 1; and
s ranges from 2 to 4.

8. The method according to claim 1, wherein the material comprises cathode active material of formula Li₍₁₊ₓ₎(NiₐCo_{b}Mn_{c}M′_{d})₍₁₋ₓ₎O₂, wherein:
M′ is selected from the group consisting of Mg, Ca, Ba, Al, Ti, Zr, Zn, Mo, V and Fe;
$$zero \leq x \leq 0.2 ;$$
$$0.1 \leq a \leq 0.95 ,$$
$$zero \leq b \leq 0.9 , or 0.05 < b \leq 0.5 ;$$
$$zero \leq c \leq 0.6 ;$$
$$zero \leq d \leq 0.1 ; and$$
$$a + b + c + d = 1.$$

9. The method according to claim 1, wherein the material comprises cathode active material of formula Li[NiₕCoᵢAlⱼ]O₂₊ᵣ, wherein:
h ranges from 0.8 to 0.95;
i ranges from 0.1 to 0.3;
j ranges from 0.01 to 0.10; and
r ranges from zero to 0.4.

10. The method according to claim 1, wherein the material comprises cathode active material of formula Li(1+x)Mn_{2-x-z}M′_{z}O₄, wherein:
x ranges from zero to 0.2;
z ranges from zero to 0.1; and
M′ is selected from the group consisting of Al, Mg, Ni, Co, Fe, Ti, V, Zr and Zn.

11. The method according to claim 1, wherein the material comprises cathode active material of formula xLi_{(1+1/3)}M_{(2/3)}O₂·yLiMO₂·zLiM′O₂, wherein M′ comprises at least one metal of oxidation state +4.

12. The method according to claim 11, wherein the material comprises cathode active material of formula xLi_{(1+1/3)}M_{(2/3)}O₂·yLiMO₂·zLiM′O₂, wherein M comprises at least one metal of Mn, Ni, Co of oxidation state +4, M′ is at least one transition metal, and 0<x<1, 0<y<1, 0<z<1 and x+y+z=1.

13. The method according to claim 1, wherein the material comprises at least one lithium ion battery material selected from the group consisting of a lithium ion battery, lithium ion battery waste, lithium ion battery production scrap, a black mass, lithium ion cell production scrap, lithium ion cathode active material, and combinations thereof.

14. (canceled)

15. (canceled)

16. (canceled)

17. (canceled)

18. A method comprising:
extracting one or more metals from a material according to claim 1 to obtain an aqueous solution comprising metal ions, and
separating the metal ions to obtain at least one essentially pure metal ion solution and/or at least one essentially pure solid metal ion salt.

19. A method for recycling at least one battery material selected from the group consisting of a lithium ion battery, lithium ion battery waste, lithium ion battery production scrap, lithium ion cell production scrap, lithium ion cathode active material, and combinations thereof, wherein the method comprises:
optionally, heat treating the at least one battery material at a temperature ranging from 350° C. to 900° C.,
mechanically comminuting the at least one battery material to obtain a black mass, optionally, sorting the black mass to obtain a fine fraction and a course fraction, and subjecting the black mass, optionally the fine fraction, the course fraction, or the fine fraction and the course fraction, to the method according to claim 1.

20. The method according to claim 1, wherein the material comprises one or more metals in a zero oxidation state and one or more selected from the group consisting of metal oxides, metal hydroxides, and combinations thereof, and wherein the method comprises:
contacting the material with an oxidizing acidic aqueous solution having a pH less than 6 at a temperature in the range of from 20° C. to 100° C. for a duration ranging from 10 minutes to 10 hours, and
subsequently reducing the one or more selected from the group consisting of metal oxides, metal hydroxides, and combinations thereof present in the material with an alkyl carbonate at a temperature in the range of from 20° C. to 100° C. for a duration ranging from 10 minutes to 10 hours.

21. (canceled)

22. The method according to claim 20, wherein the material is an ore comprising from 0.1 weight % manganese to 65 weight % manganese, by total weight of the material.

23. The method according to claim 22, wherein the material comprises pyrolusite.

24. The method according to claim 20, wherein the material is from a manganese ore extraction.

25. (canceled)

26. (canceled)

27. (canceled)

28. (canceled)

29. The method according to claim 19, wherein the reducing step further comprises contacting the material with one or more selected from the group consisting of SO₂, metabisulfite salts, bisulfite salts, thiosulfate salts, H₂O₂, H₂, and combinations thereof.

30. (canceled)

31. (canceled)

32. (canceled)

33. (canceled)

34. (canceled)

35. (canceled)

36. (canceled)

37. (canceled)
